(19) United States
(12) Patent Application Publication
(10) Pub. No.: US 2026/0062647 A1
(43) Pub. Date: Mar. 5, 2026

(54) Cleaning Formulation

(71) Applicant: Richard Eklund, Las Vegas, NV (US)

(72) Inventor: Richard Eklund, Las Vegas, NV (US)

(21) Appl. No.: 18/821,213

(22) Filed: Aug. 30, 2024

(51) Int. Cl. C11D 1/66; C11D 3/00; C11D 3/20; C11D 3/30; C11D 3/33

(52) U.S. Cl. CPC C11D 1/662; C11D 3/0047; C11D 3/2017; C11D 3/2044; C11D 3/30; C11D 3/33; C11D 2111/14

(57) ABSTRACT

A cleaning formulation for cleaning a sports paddle has (by weight) the following: 75-90% water; 3-7% Isopropyl Alcohol; and 1-5% Functionalized Alkyl Polyglucosides. The formulation has a pH of 7.5-9.5. The cleaning formulation is effective in removing plastic dust and other waste from the sports paddle, providing superior cleaning performance.

### BACKGROUND OF THE INVENTION

### Field of the Invention

This invention relates generally to cleaning formulations, and more particularly to a cleaning formulation for a sports paddle, such as a pickleball paddle.

### Description of Related Art

It is important to properly clean a sports paddle, such as a paddle used in the game of pickleball, because the surface of the paddle can become covered with plastic dust and similar debris, which interferes with the ability of the paddle to grip the ball when hit. Changes in friction can interfere with the ability of the user to hit the ball correctly, and in particular to impart a spin on the ball

The prior art teaches the use of carbon fiber cleaning pads for use in physically wiping a sports paddle. While these pads are helpful, they are not completely effective in removing plastic dust from the paddle surface.

There is a need in the art of cleaning supplies for properly cleaning a sports paddle.

### SUMMARY OF THE INVENTION

The present invention teaches certain benefits in construction and use which give rise to the objectives described below.

The present invention provides a cleaning formulation for cleaning a sports paddle. In the current embodiment, the cleaning formulation includes (by weight) the following: 75-90% water; 3-7% Isopropyl Alcohol; and 1-5% Functionalized Alkyl Polyglucosides. The formulation has a pH of 7.5-9.5, providing superior cleaning performance.

A primary objective of the present invention is to provide a cleaning formulation having advantages not taught by the prior art.

Another objective is to provide a cleaning formulation adapted to clean a sports paddle.

A further objective is to provide a cleaning formulation that is able to provide a superior cleaning of a sports paddle that removes the great majority of plastic dust and other debris that might interfere with the effectiveness of the sports paddle.

Other features and advantages of the present invention will become apparent from the following more detailed description, taken in conjunction with the accompanying drawings, which illustrate, by way of example, the principles of the invention.

### DETAILED DESCRIPTION OF THE INVENTION

The below specification describes the invention, a cleaning formulation adapted to clean a sports paddle, such as a pickleball paddle.

In the current invention, the cleaning formulation includes Functionalized Alkyl Polyglucosides. In the current embodiment, the Functionalized Alkyl Polyglucosides are preferably free of Ethylene Oxide (EO), 1,4-Dioxane, Diethanolamine (DEA), and Dichloroacetic Acid (DCA). Functionalized Alkyl Polyglucosides have been found to provide superior performance in removing plastic dust from the sports paddle, which provides superior performance for the user.

In various embodiments, the formulation is adapted to clean and sanitize a pickleball paddle, as well as other paddles used in similar sports that involve hitting a plastic ball.

In one embodiment, the formulation is thin liquid having a viscosity similar to water. However, in other embodiments, thickening agents may be included to create a gel, or in further still embodiments the formulation may be in the form of an aerosol. Any texture of the formulation may be formulated, provided the active ingredients remain effective in cleaning a sports paddle.

The current formulation contains water, along with an effective amount of Isopropyl Alcohol, Propanediol, and a surfactant. In the current embodiment, the surfactant is an environmentally friendly surfactant such as Functionalized Alkyl Polyglucosides, or other biodegradable sugars derived from plants. For purposes of this application, the term “effective amount” is defined to include an effective amount to achieve the desired cleaning and sanitizing effect, as determined by one skilled in the art of this field. The cleaning formulation may further include a chemically compatible carrier, stabilizers, and/or preservatives.

In one embodiment, the formulation further comprises 0.5-2.5% of a combination of Caprylyl Glycol and Ethylhexylglycerin, 0.2-1% Polysorbate 20 (same as Botanisil P20), 0.05-0.2% fragrance (white tea EE18-31918), approximately 0.001% Blue 1 (and) water, approximately 0.004% Yellow 5 (and) water, and approximately 0.001% Triethanolamine. All percentages are W/W. Furthermore, in alternative embodiments, other equivalent ingredients may be used within the scope of the present invention. Colorants other than Blue 1 and Yellow 5 may be used to achieve a generally green liquid color, or they may be used in different amounts, or other liquid colors may be created, as desired by the consumer. Triethanolamine may be excluded, depending on the pH balance resulting from the previous ingredients, discussed further below.

The present application also provides a method of manufacturing the cleaning formula. In one embodiment of the method, the formulation is created through the following phases:
PHASE A: Add water to main compounding tank (MCT) and begin mixing. Add remaining phase A materials and mix well. Phase A materials include 86.094%, water, 4% Propanediol, 3% Functionalized Alkyl Polyglucosides, 0.1% Tetrasodium Glutamate Diacetate 0.1%, and 5% Isopropyl Alcohol. Percentages are of total final volume.
PHASE B: add materials to MCT and mix well. Phase B materials include 1.2% Caprylyl Glycol (and) Ethylhexylglycerin.
PHASE C: pre-mix materials, then add to MCT and mix well. Phase C materials include 0.5% Polysorbate 20 (same as Botanisil P20), and 0.1% fragrance (white tea EE18-31918). Obviously, other fragrances may be used, and the disclosed embodiment is intended only for the purpose of example.
PHASE D: add materials incrementally to MCT to QS color standard and mix well. Phase D materials include 0.001% Blue 1 (and) water, and 0.004% Yellow 5 (and) water.
PHASE E: check pH, add materials incrementally (if necessary) to increase pH to 8.05-9.0, preferably by adding approximately 0.001% Triethanolamine.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A cleaning formulation for cleaning a sports paddle, said cleaning formulation comprising:
75-90% water;
3-7% Isopropyl Alcohol;
1-5% Functionalized Alkyl Polyglucosides; and
wherein the formulation has a pH of 7.5-9.5,
wherein all percentages are by weight.

2. The cleaning formulation of claim 1, further comprising Triethanolamine added in an amount necessary to achieve the desired pH.

3. The cleaning formulation of claim 1, further comprising 0.5-2.5% of a combination of Caprylyl Glycol and Ethylhexylglycerin, and 0.2-1.0% Polysorbate.

4. The cleaning formulation of claim 1, wherein the formulation is a water-thin liquid.

5. The cleaning formulation of claim 1, further comprising a fragrance and a colorant.

6. The cleaning formulation of claim 1, further comprising 2-6% Propanediol.

7. A cleaning formulation for cleaning a sports paddle, said cleaning formulation comprising, by weight:
about 86% water;
about 5% Isopropyl Alcohol;
about 4% Propanediol;
about 3% Functionalized Alkyl Polyglucosides;
about 0.1% Tetrasodium Glutamate Diacetate; and
Triethanolamine in an amount that maintains the formulation at a pH of 8.05-9.
